(19) United States
(12) Patent Application Publication
(10) Pub. No.: US 2006/0016867 A1
(43) Pub. Date: Jan. 26, 2006

(54) Product history management apparatus and system, and identification information issuing apparatus

(76) Inventors: Kazuo Tani, Chiba-shi (JP); Norimitsu Sambongi, Chiba-shi (JP)

Correspondence Address: BRUCE L. ADAMS, ESQ., 50 BROADWAY-31ST FLOOR, NEW YORK, NY, 10004, US

(21) Appl. No.: 11/166,972

(22) Filed: Jun. 24, 2005

(30) Foreign Application Priority Data
Jul. 22, 2004 (JP) 2004-214360
May 18, 2005 (JP) 2005-145253

(51) Int. Cl. G06F 7/00; G06F 17/00

(52) U.S. Cl. 235/376; 235/375

(57) ABSTRACT

To manage a product history using a recording medium and provide more additional information using the recording medium. A label ID is issued for all steps from raw material production to retail product production, and a label ID issued in a given step and a label ID issued in a previous step are associated to keep a history of the label IDs, making it possible to grasp a product history from a raw material to a final product. Further, access information to a predetermined website is embedded to a label in the final step, which is put on a product delivered to a consumer, through digital watermarking. When photographing a label with a portable terminal having a predetermined function, the consumer can automatically access the predetermined website by means of the portable terminal.

### BACKGROUND OF THE INVENTION

1. Field of the Invention

The present invention relates to a product history management apparatus and system, and an identification information issuing apparatus, and more specifically to a technique for managing a product history and providing a consumer with information sent from an operator (manufacturer, provider, retailer, etc.) engaged in product manufacture.

2. Description of the Related Art

In response to a recent increase in public concern over the safety of food products and pharmaceuticals, there is a growing demand to establish a product history management system capable of managing a product history from production to delivery to a consumer.

Japanese Patent Application No. 2004-127516, which is filed as a precedent application by the applicant of the present invention, proposes such a product management system.

With the disclosed technique, a label ID is issued in all steps from raw material production to retail product production (retailer and food-service distributor), and a label ID issued in a given step and a label ID issued in a previous step are associated to keep a history of the label IDs, making it possible to grasp a product history (production/processing history, distribution history, etc.) from raw material to final product.

A label management server issues a label ID and manages a history of issued label IDs, and label issuing apparatuses set for each step print a label and manage detailed information on a product in each step.

Pieces of the detailed information accumulated in each label issuing apparatus are linked with one other using the label IDs associated by the label issuing server, enabling management of the product history from production to delivery to a consumer.

In addition, the detailed information on the product can be distributed to the label issuing apparatuses, reducing loads on the label management server.

Here, operators engaged in production desire to print more information such as information on their own companies and advertisements on a label, for example.

Besides, in some cases, the tourist association in the operator's address desires to introduce some sight spots as part of economic development projects in the area.

However, against such demands, there is a problem in that a printable area of a label is limited, and many items need to be originally printed on the label, so only a limitative amount of information can be provided to a consumer.

### SUMMARY OF THE INVENTION

It is therefore an object of the present invention to manage a product history using a recording medium and besides, provide more additional information using the recording medium.

In order to attain the above-mentioned object, the present invention provides a product history management apparatus used for a product history management system for managing a product history by attaching a recording medium having recorded identification information to products provided in steps from raw material production to final product production, including: identification information receiving means for receiving identification information recorded on the recording medium attached from an identification information issuing apparatus in a previous step; identification information transmitting means for transmitting newly issued identification information to the identification information issuing apparatus; identification information storage means for storing the received identification information and the transmitted identification information in association with each other; and access information transmitting means for transmitting access information to a predetermined site to be recorded together with the transmitted identification information, to the identification information issuing apparatus (first structure).

The product history management apparatus according to the first structure may further include: posting information accepting means for accepting registration of posting information to be posted on the predetermined website from operators in each of the steps; and posting means for posting the accepted posting information on the predetermined website (second structure).

In the product history management apparatus according to the second structure, the posting information may be access information to a website designated by the operator (third structure).

Further, the present invention provides an identification information issuing apparatus used for a product history management system for managing a product history by attaching a recording medium having recorded identification information to products provided in steps from raw material production to final product production, including: identification information transmitting means for transmitting identification information recorded on the recording medium attached in a step previous to a step where the identification information issuing apparatus is set, to a product history management apparatus; identification information receiving means for receiving identification information issued with respect to the transmitted identification information from the product history management apparatus; and recording means for obtaining access information to a predetermined website and recording the received identification information and the access information on the recording medium (fourth structure).

In the identification information issuing apparatus according to the fourth structure, the recording medium may be a print medium, and the recording means may print the access information to be superimposed on visible information in a form of a digital watermark readable with a terminal device having a digital-watermark-reading function (fifth structure).

Further, the present invention provides a product history management system for managing a product history by attaching a recording medium having recorded identification information to products provided in steps from raw material production to final product production, including: a plurality of identification information issuing apparatuses set for each of the steps; and a product history management apparatus connected with the identification information issuing apparatuses via a network, the identification information issuing apparatuses transmitting identification information recorded on the recording medium attached in a previous step to the product history management apparatus, the product history management apparatus receiving the transmitted identification information, newly issuing identification information, storing the issued identification information and the received identification information in association with each other, and transmitting the issued identification information and access information to a predetermined website to the identification information issuing apparatus set for the step, the identification information issuing apparatus, which has transmitted the identification information, receiving the transmitted identification information and access information to the predetermined website, and storing the received information on the recording medium (sixth structure).

According to the present invention, it is possible to manage a product history using identification information recorded on a recording medium and besides, attach additional information to the recording medium irrespective of its recording capacity.

### BRIEF DESCRIPTION OF THE DRAWINGS

In the accompanying drawings:

FIG. 1 shows a network configuration of a label management system;

FIG. 2 illustrates how to link label IDs;

FIG. 3 shows a logical configuration of a detailed information database;

FIGS. 4A and 4B each show an example of a label;

FIG. 5 shows an example of a retrieval screen;

FIG. 6 shows an example of a search result screen;

FIG. 7 shows an example of a detailed information screen;

FIG. 8 is an external view of a portable phone used in an embodiment of the present invention;

FIG. 9 shows how an operator website is accessed by use of the portable phone;

FIG. 10 is a flowchart illustrative of a procedure of accessing the operator website by use of the portable phone; and

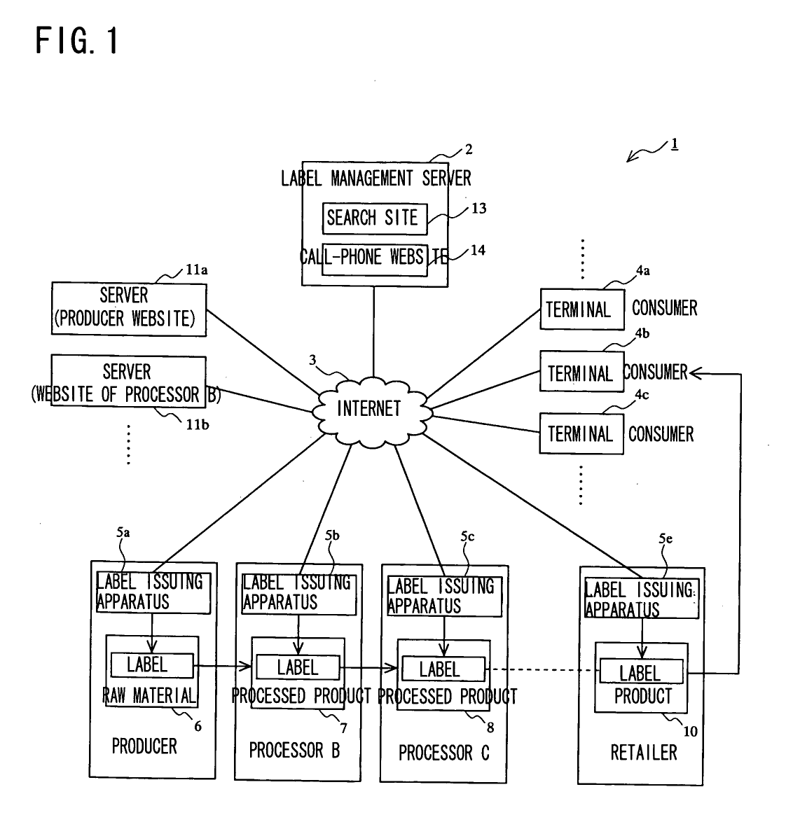

FIGS. 1A and 11B each show a hardware configuration of a label management server.

### DETAILED DESCRIPTION OF THE PREFERRED EMBODIMENT

### (1) Summary of Embodiment

A label management system according to an embodiment of the present invention is configured such that a label ID is issued for all steps from raw material production to retail product production (retailer and food-service distributor), and a label ID issued in a given step and a label ID issued in a previous step are associated to keep a history of the label IDs, making it possible to grasp a product history from a raw material to a final product.

In addition, access information to a predetermined website (in this embodiment, cell-phone website run by a label management server) is embedded to a label in the final step, which is put on a product delivered to a consumer, through digital watermarking.

Photographing a label with a portable terminal having a predetermined function (in this embodiment, portable phone having a photographing function of a built-in camera, and a function of extracting access information recorded through the digital watermarking from taken image data, and a function of automatically accessing an address indicated by the extracted access information), the consumer can automatically access the predetermined website by means of the portable terminal.

In this way, the access information is printed on the label through the digital watermarking while superimposed on visible information (normal indication contents), making it possible to save space for the access information to be printed and automatically access an address indicated by the access information by means of the portable terminal having the predetermined function.

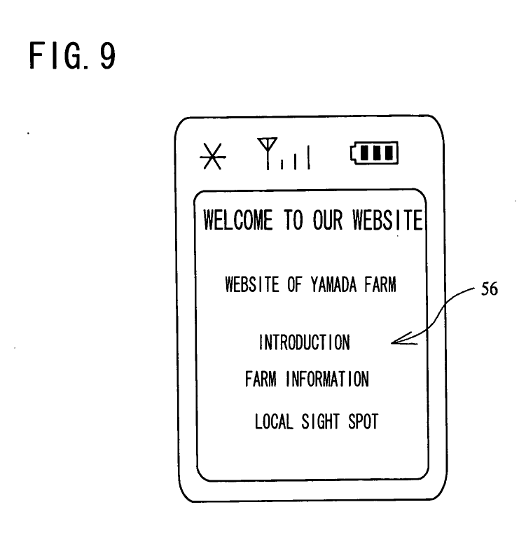

As shown in FIG. 8, links to operators' websites are listed on the cell-phone website, and the consumer can access a linked website by selecting a desired link by means of the portable terminal.

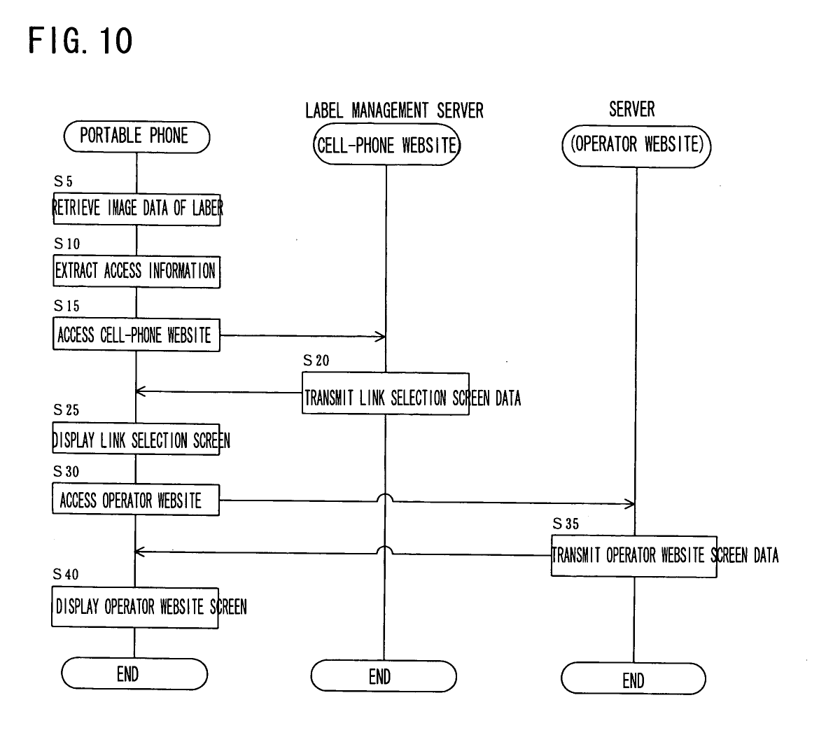

As shown in FIG. 9, an operator introduces his/her own company, provides product information, and promotes and advertises a product, on the accessed website, for example.

Viewing the provided information on the website, the consumer can know a product that he/she consumes (eats, drinks, etc.) and feel safe in the product, and in addition, obtain beneficial information thereon.

Further, the operator can provide various kinds of information irrespective of a printable area of a label.

Any general print is limited in that only printed information can be provided. However, the contents posted on the website can be updated as needed, so the latest information can be provided to the consumer in real time by means of a label by linking the printed information and the website.

### (2) Details of Embodiment

FIG. 1 conceptually shows a network configuration of a label management system 1 according to this embodiment.

The label management system 1 gives label IDs in respective steps in manufacturing process for food products, pharmaceuticals, etc. from the raw material production to final product production, and traces a history thereof, which is particularly effective when applied to a manufacturing process where plural operators engage in processing of a product in different steps.

From now on, description will be given of a case where the label management system 1 is applied to production of a beef product from slaughter to retail as an example.

The label management system 1 is provided with a label management server 2, terminals 4a, 4b, 4c, . . . , label issuing apparatuses 5a, 5b, 5c, 5d, and 5e, and servers 11a, 11b, . . . , which are connectable with one another via the Internet 3.

Note that in the following, the terminals 4a, 4b, 4c, . . . , the label issuing apparatuses 5a, 5b, 5c, 5d, and 5e, and the servers 11a, 11b, . . . are simply referred to as the terminal(s) 4, the label issuing apparatus(es) 5, and the server(s) 11, respectively unless otherwise specified.

The label management server 2 has: a history management function of managing a label ID to be printed to a labeling target such as a raw material, a processed product, or a retail product; a detailed information providing function of accepting an access from a consumer on a search site 13 and providing the consumer with detailed information on products in each processing step; and an operator information providing function of providing the consumer with operator information posted on the search site 13 or cell-phone website 14 by operators in each step (hereinafter, simply referred to as “operators”).

Hereinafter, those functions will be respectively described.

(History Management Function)

The label management server 2 receives a label ID printed on a label affixed onto a product in a previous step from each label issuing apparatus 5, and transmits a newly issued label ID to the label issuing apparatus 5 in question.

The label management server 2 stores the received label ID and the transmitted label ID in association with each other.

The label management server 2 can trace a product distribution process by tracing the associations between the label IDs thus stored.

Here, the label management server 2 corresponds to a product history management apparatus, and each label issuing apparatus 5 corresponds to an identification information issuing apparatus.

Then, as described above, the label management server 2 includes: identification information receiving means for receiving a label ID (corresponding to identification information) recorded on a label (corresponding to a recording medium) attached in a previous step by the label issuing apparatus 5; and identification information storing means for issuing a new label ID relative to the received label ID, and storing the new label ID associated with the received label ID in a label ID management database 55 as will be described below.

(Detailed Information Providing Function)

First of all, receiving a request from a consumer to provide the consumer with a product history based on a label ID printed on a label affixed onto a product on the search site 13, the label management server 2 searches the label ID management database 55 for a series of label IDs associated with the label ID concerned, and provides the search result to the consumer.

Next, receiving a request from the consumer to present detailed information corresponding to the provided label ID, the label management server 2 requests the label issuing apparatus 5 storing the detailed information to provide the same, and resultingly presents the detailed information obtained from the label issuing apparatus 5 to the consumer.

As discussed below, the label issuing apparatus 5 stores the detailed information in the processing step and the label ID in association with each other, and the label management server 2 can obtain the detailed information from the label issuing apparatus 5 by designating a desired label ID.

(Operator Information Providing Function)

The label management server 2 sends access information to the cell-phone website 14 together with the label ID issued beforehand to the label issuing apparatus 5e, and those information are printed by the label issuing apparatus 5e.

In this way, the label management server 2 has access information transmitting means for transmitting the label ID issued beforehand, and the access information to the cell-phone website 14 (corresponding to a predetermined website) to the label issuing apparatus 5.

Printed on a label issued by the label issuing apparatus 5e is access information to the cell-phone website 14 through the digital watermarking. Thus, if photographing the label with a camera-equipped portable phone as described below, the consumer can automatically access the cell-phone website 14.

The access information includes a URL (uniform resource locators), for example.

Some links to websites run by the respective operators (hereinafter referred to as “operator websites”) are set on the cell-phone website 14. The consumer can access each operator website by selecting a desired one of the links.

The operator websites are independently run by the respective operators, and provide information beneficial for consumers and operators.

Next, the label issuing apparatuses 5 will be described.

The label issuing apparatuses 5 are set for respective steps from a step of slaughtering cattle into beef at a slaughterhouse (label issuing apparatus 5a) to a step of processing the beef. (label issuing apparatuses 5b, 5c, and 5d) and further to a step of retailing the beef product (label issuing apparatus 5e), and have a label printing function and a detailed information management function.

The label issuing apparatuses 5 can make communications with the label management server 2 via the Internet 3 to constitute a network-linked printing apparatus.

(Label Printing Function)

Each label issuing apparatus 5 transmits a label ID issued in a previous step and printed on a label affixed onto a product to the label management server 2, and then receives a label ID newly issued by the label management server 2 with respect to the label ID to thereby print the received label ID on a label.

The label ID in the previous step is transmitted to the label management server 2 by an operator inputting the label ID printed on the label affixed to the product in the previous step to the label issuing apparatus 5.

The operator affixes the label printed this time onto a processed product.

Further, the label issuing apparatus 5e set for the final step prints access information to the cell-phone website 14 on the label through the digital watermarking.

The access information is sent from the label management server 2 to the label issuing apparatus 5. The access information may be received from the label management server 2 each time a label is issued, or may be received from the label management server 2 every predetermined period and stored based on batch processing etc., the stored access information being repeatedly used.

To elaborate, the label issuing apparatus 5e transmits a label ID in a previous step to the label management server 2 (corresponding to identification information transmitting means), and receives a label ID transmitted from the label management server 2 with respect to this label ID (identification information receiving means).

Then, the label issuing apparatus 5e has recording means for obtaining access information to the cell-phone website 14 transmitted from the label management server 2 (it is possible to receive the information together with a label ID, or retrieve information previously received and stored), and recording the access information together with the label ID received from the label management server 2 on a label.

In this way, the label management server 2 has a digital-watermarking information providing function of providing the label issuing apparatus 5e with digital-watermarking information to be printed through the digital watermarking, and in addition, the label issuing apparatus 5e has a digital-watermark printing function of printing a digital watermark using the digital-watermarking information.

As a digital watermarking method, a variety of known methods such as a density pattern method and a random pit plane method have been put into practical use. Thus, any one fitted for the object of the present invention (enable to photograph with a digital phone and automatically access a website) may be selected from among those methods.

More specifically, as the digital watermarking method, various methods targeted for a binary image or grayscale image are proposed. In this embodiment, the method targeted for the binary image is preferred for the purpose of printing a digital watermark on a product label.

Further, as a digital watermarking method for a binary image, there are known the density pattern method, a systematic dithering method, and an error diffusion method.

(Detailed Information Management Function)

Regarding the way to manage the detailed information, when a processor processes the product, he/she may input detailed information on the product (for example, weight of beef, quarantine inspection results, an address and name of a producer, a slaughter date, and BSE test results) to the label issuing apparatus 5. The label issuing apparatus 5 stores the label ID assigned to the product in association with the detailed information in a storage device.

In this way, the label management system 1 can hold the detailed information in a form of being distributed to the label issuing apparatuses 5 set for respective steps, which reduces a load on the label management server 2.

In response to a request to transmit detailed information from the label management server 2, the label issuing apparatus 5 reads requested detailed information associated with a label ID from the storage device and sends the read information to the label management server 2.

Further, if desiring to obtain information regarding the product in a previous step, the operator can obtain detailed information from the label issuing apparatus 5 set in any preceding (upstream) step by making reference to the label management server 2 about a label ID issued in a previous step.

The above operation is performed such that the label management server 2 searches the label ID management database 55 for associations with the received label ID, and obtains detailed information associated with the retrieved label ID from the label issuing apparatus 5 that stores the detailed information and then provides the obtained information.

Next, the server 11 will be described.

The server 11 is a web server for running an operator website containing information provided to consumers by operators (producer, a processor B, . . . )

The website is accessed by a consumer using the terminal 4, a portable phone, or other such terminal devices, to provide the consumer with information that each operator wishes to send, such as information on a product, operation information, promotion information, advertisements, and information on specialty goods and sight spots.

Note that the portable phone is inferior to the terminal 4 in an information processing ability and display ability, so the server 11 prepares two types of data for the terminal 4 and the portable phone, for example, to deal with both the devices.

Next, the terminal 4 will be described.

The terminal 4 is, for example, a terminal device accessible to the Internet 3 such as a personal computer, which enables a consumer to access the label management server 2 and the server 11.

The consumer accesses the search site 13 of the label management server 2 by means of the terminal 4 to input a label ID printed on a label of a product, thereby searching for a product history of the product.

Also, the consumer can access a website run by an operator by way of the server 11.

Although not shown, the label management system 1 may include a portable phone having a function of photographing with a built-in camera, a function of extracting access information (URL etc.) embedded through the digital watermarking from the taken image by image processing, and a function of automatically accessing a website specified according to the extracted access information.

When a consumer photographs a label with the above portable phone, the portable phone can read the access information embedded through the digital watermarking from the label, and automatically access the cell-phone website 14.

Note that in this embodiment, the portable phone is used as an example of the portable terminals, but various other portable terminals such as a PDA (personal digital assistant) or portable game machine can be used instead.

In addition, when the label management system 1 needs to deal with such a portable phone having a function of accessing the Internet but not having a function of extracting the digital watermark, it is possible that the access information is previously printed on a label as visible information, and then manually inputted to the portable phone, or the access information is printed on a label in any other form such as a two-dimensional barcode form, and a portable phone conforming to such a form is used.

Note that in this embodiment, the Internet 3 is adopted as a network for operating the label management system 1. However, the present invention is not limited thereto. Instead, a system may be configured, for example, by a LAN (local area network), a WAN (wide area network), or other such networks.

Here, the label ID constitutes identification information, and a label constitutes a recording medium for recording the identification information.

Further, the label management system 1 constitutes a product history management system for managing a product history by attaching a recording medium having recorded the identification information to products in respective steps from a raw material production to a final product production.

Further, the label management server 2 constitutes a product history management apparatus having: identification information receiving means for receiving identification information recorded on a recording medium attached (in this embodiment, affixed) in a previous step from an identification information issuing apparatus; identification information transmitting means for transmitting newly issued identification information to the identification information issuing apparatus; identification information storage means for storing the received identification information and the transmitted identification information in association with each other (label ID management database 55); and access information transmitting means for transmitting access information to a predetermined website, which is to be recorded together with the transmitted identification information, to the identification information issuing apparatus.

Further, the label issuing apparatus 5 constitutes an identification information issuing apparatus having: identification information transmitting means for transmitting identification information recorded on a recording medium attached in a step previous to a step where the identification information issuing apparatus is set, to a product history management apparatus through the operator's inputting operation; identification information receiving means for receiving the identification information issued with respect to the transmitted identification information from the product history management apparatus; and recording means for obtaining access information to a predetermined website and recording the received identification information and the access information on a recording medium.

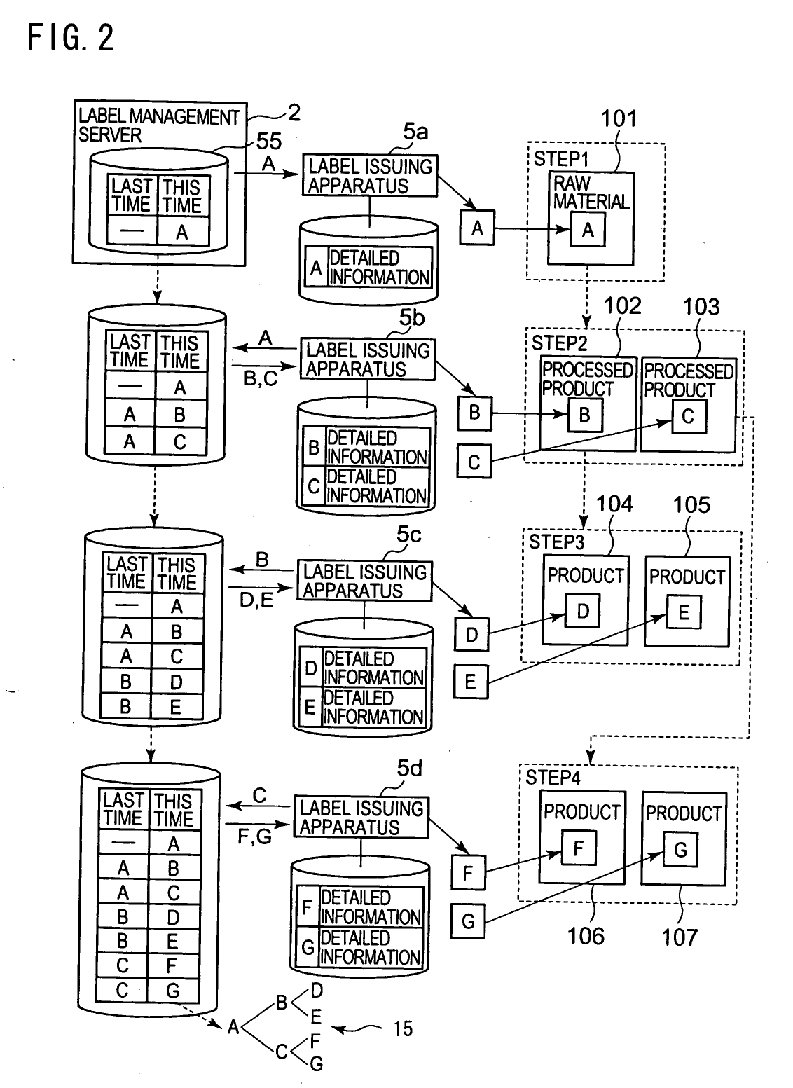

FIG. 2 is a conceptual diagram illustrative of how to link label IDs through the cooperation between the label management server 2 and the label issuing apparatus 5.

The label management server 2 includes the label ID management database 55 for storing and managing the issued label IDs. The label ID management database 55 stores a label ID issued in the previous step and a label ID issued this time in association with each other.

In FIG. 2, the label ID issued in the previous step is represented by “last time” and the label ID issued this time is represented by “this time” and both the label IDs are associated.

The label management server 2 stores the label ID transmitted from the label issuing apparatus 5 in the field of “last time” of the label ID management database 55 and stores the label ID transmitted to the label issuing apparatus in the field of “this time” thereof.

The label management server 2 thus structured issues a label ID (A) (hereinafter, referred to as label ID-A) for step S1 from which a series of processings is started, and transmits it to the label issuing apparatus 5a. The label ID-A is stored in the label ID management database 55.

The label issuing apparatus 5a receives the label ID-A from the label management server and prints the label ID-A on a label. The printed label is affixed on a raw material 101.

At this time, detailed information about the raw material (for example, slaughter date or BSE test result) can be inputted to the label issuing apparatus 5a. The label issuing apparatus 5a can store the label ID in association with the detailed information.

Next, it is assumed that the raw material 101 is shipped to the next place (step S2) and a processed product 102 and a processed product 103 are produced from this material.

In step S2, first, the label ID-A printed on the label is inputted to the label issuing apparatus 5b and transmitted to the label management server.

The label management server receives and stores the label ID-A in the label ID management database 55 to issue a label ID-B and a label ID-C to the processed products 102 and 103, respectively. The server transmits the issued label IDs to the label issuing apparatus 5b and stores the label ID-B and the label ID-C in association with the previously received label ID-A in the label ID management database 55.

The label issuing apparatus 5b prints the label ID-B and the label ID-C transmitted form the label management server on labels. The printed labels are respectively affixed to the processed products 102 and 103, and the products are transferred to the next step.

Also, the label issuing apparatus 5b stores detailed information about the processed products 102 and 103 in association with the label ID-B and the label ID-C, respectively.

Next, consider the case where the processed product 102 is transferred to step S3, and products 104 and 105 are produced.

Instep S3, the label ID-B printed on the label on the processed product 102 is inputted to the label issuing apparatus 5c and transmitted to the label management server.

The label management server stores the label ID-B in the label ID management database 55 and besides, issues a label ID-D and a label ID-E for the products 104 and 105 produced in this step. The label management server then transmits the label ID-D and the label ID-E to the label issuing apparatus 5c while storing those IDs in association with the label ID-B in the label ID management database 55.

The label issuing apparatus 5c prints the label ID-D and the label ID-E transmitted from the label management server on labels. The printed labels are respectively affixed onto the products 104 and 105 that are retailed to the consumers.

The label issuing apparatus 5c also stores detailed information inputted with respect to the products 104 and 105, in association with the label ID-D and the label ID-E, respectively.

Meanwhile, it is assumed that the processed product 103 prepared in step S2 is transferred to step S4 and products 106 and 107 are produced using the processed product 103.

Similar to step S3, the label management server stores a label ID-F and a label ID-G in association with the label ID-C of the label on the processed product 103, and the label issuing apparatus 5d prints the label ID-F and the label ID-G on labels.

The products 106 and 107 affixed with those labels are then retailed to the consumers.

With the above procedures, created in the label ID management database 55 is linkage information 15 representative of linkages between label IDs, and information on a consecutive relation among all label IDs from an ID for the raw material 101 to IDs for the products 104 to 107 is recorded in the database.

In addition, the detailed information in each step are stored in association with the label IDs in the label issuing apparatuses 5a to 5d. Then, by using a label ID, the detailed information associated with the label ID can be obtained from the label issuing apparatus 5.

The history of the label IDs and detailed information associated with each label ID are open to the consumers on the search site 13 (FIG. 1) over the Internet, and the consumers can trace the history of a purchased product from a raw material to a final product in each step by using the label ID printed on the label affixed onto the product.

For example, the consumer who purchased the product 107 searches the label ID management database 55 for a label ID, and acquires information that the product is produced through the steps of A, C, and G in this order. Further, the consumer makes an inquiry about the label ID-C using the label issuing apparatus 5c and can obtain detailed information about the processed product 103.

Note that in the above example, for example, the label IDs are individually issued to the products 104 and 105 in step S3. However, the products produced under the same conditions and in the same step can be uniformly given the same label ID.

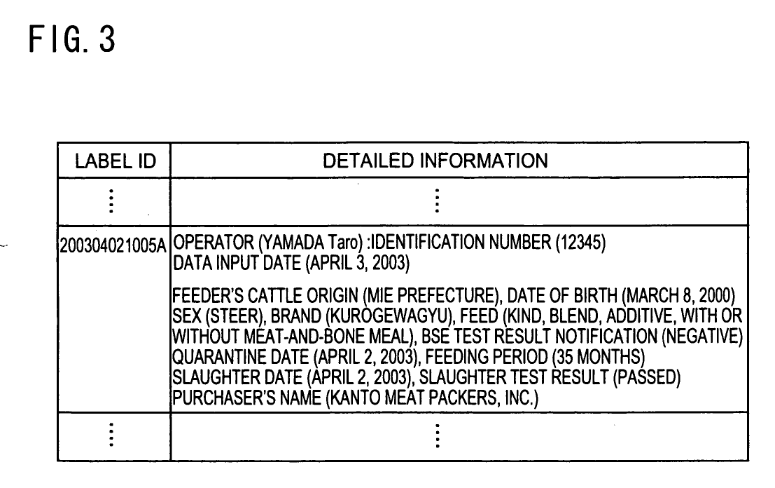

FIG. 3 shows an example of a logical configuration of a detailed information database in the label issuing apparatus 5.

As shown in FIG. 3, the detailed information database stores the label IDs issued by the label management server 2 and the detailed information inputted by an operator in association with each other.

Thus, receiving a request to send detailed information from the label management server 2 based on a label ID, the label issuing apparatus 5 searches the detailed information database for a label ID, and reads the detailed information associated with the label ID to send the read information to the label management server 2.

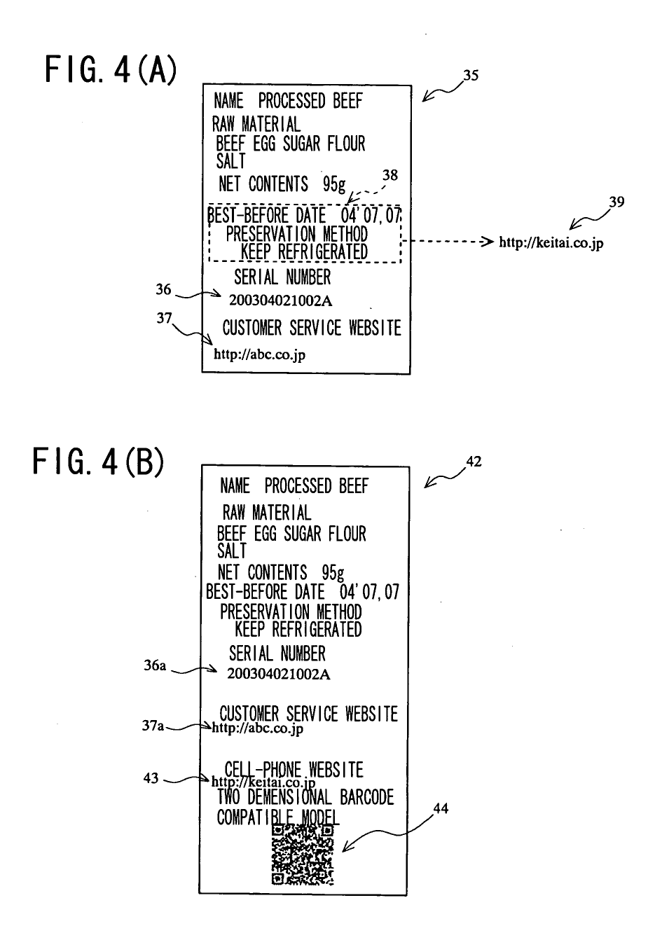

FIG. 4A shows an example of a label issued by the label issuing apparatus 5e (FIG. 1) and affixed onto a retail product.

Printed on a label 35 by the label issuing apparatus 5e are normal label indication such as the name, raw material, net contents, best-before date, and preservation method of a product, and besides, a label ID 36, access information 37 to the search site 13, and access information 39 to the cell-phone website 14 printed on an area 38 through the digital watermarking.

The digital watermark is printed in a designated area of the label 35 based on black-and-white printing, and gray and chromatic color printing.

In this way, invisible information (digital watermark) is printed while superimposed on visible information, whereby more information can be recorded on a limited printable area.

Note that in this embodiment, the access information is printed through the digital watermarking, but as a modified example, the access information can be printed in a visible form as shown in FIG. 4B.

Printed on the label 42 are access information 43 to the cell-phone website 14 and a two-dimensional barcode 44 as well as a label ID 36a and access information 37a to the search site 13.

If the portable phone of a consumer is incompatible to a digital watermark, the consumer can access the cell-phone website 14 by pressing buttons on the portable phone to input the access information 43.

When a portable phone of a consumer is given a photographing function and besides, a function of extracting and analyzing a two-dimensional barcode from a taken image, and a function of automatically accessing a website using the access information recorded in the two-dimensional barcode form, the consumer can automatically access the cell-phone website 14 by use of the portable phone by photographing the two-dimensional barcode 44 with the portable phone.

Further, if the access information 39 is printed on the label 42 through the digital watermarking, it is possible to cover all of a portable phone compatible to the digital watermark, a portable phone compatible to the two-dimensional barcode, and a portable phone incompatible to the two.

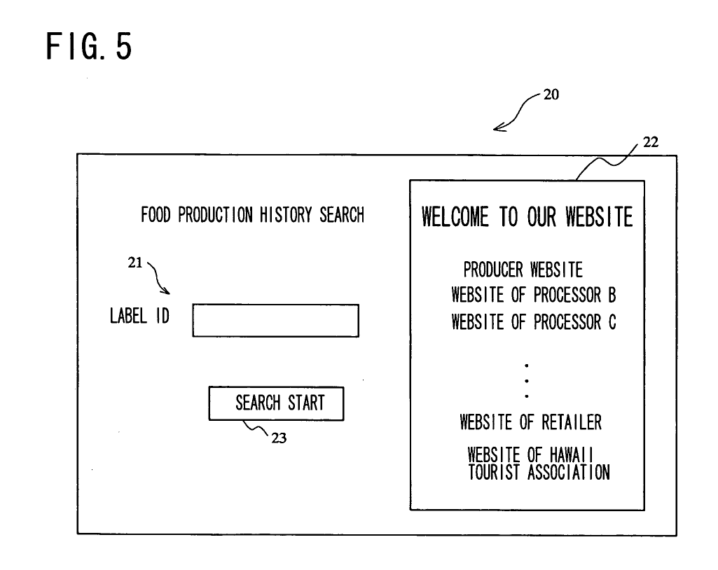

FIG. 5 shows an example of a retrieval screen provided by the search site 13.

When a consumer enters access information to the search site 13, to a browser of the terminal 4 and accesses the search site 13, the retrieval screen 20 is displayed on a display of the terminal 4.

The search screen contains a label ID entry field 21, a search start button 23, and a link list box 22.

The label ID entry field 21 is used for a consumer to enter a label ID printed on a label affixed to a product.

The consumer checks the label ID printed on the label and enters the label ID to the label ID entry field 21 using a keyboard or the like.

The search start button 23 is used for starting a search for the product history. The consumer clicking the search start button 23 with a mouse, the label ID entered into the label ID entry field 21 is transmitted to the label management server 2 to start searching for the linkage information 15 among label IDs.

The link list box 22 displays links to a desired operator website.

When the consumer selects a desired operator in the link list box 22, the access information to the operator website is sent from the label management server 2. Then, the terminal 4 accesses the selected operator website using the access information.

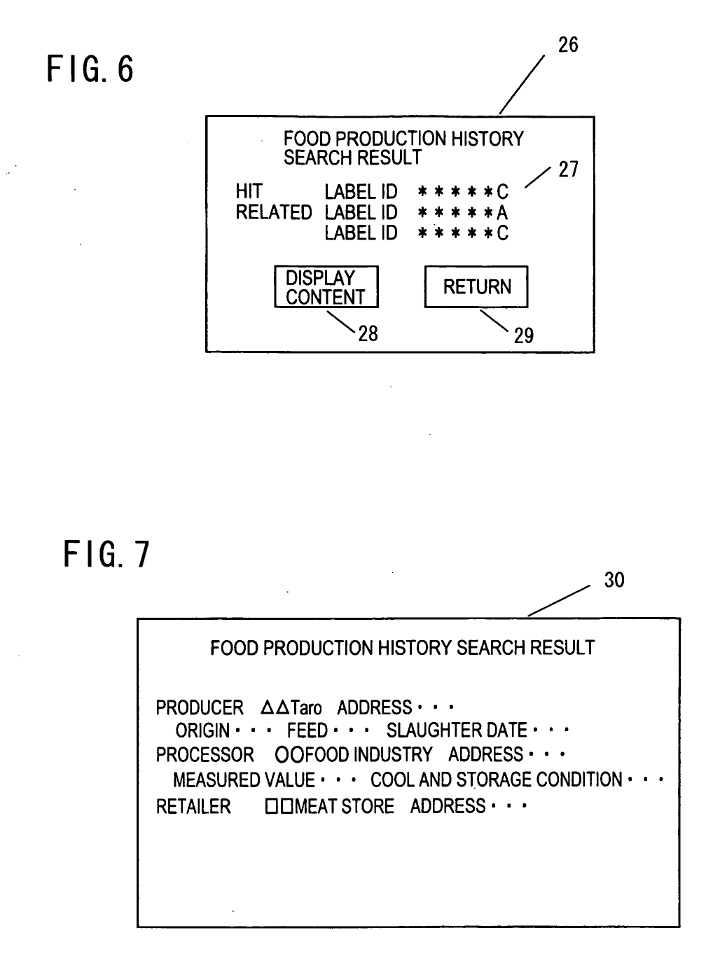

FIG. 6 shows an example of a search result screen provided by the search site 13.

The search result screen 26 is displayed on the terminal 4 by the consumer entering the label ID in the label ID entry field 21 (FIG. 5) and clicking the search start button 23.

The label management server 2 searches the label ID management database 55 (FIG. 2) using a label ID transmitted from the terminal 4 to obtain the linkage information 15, and the linkage information is used to construct this screen.

The search result screen 26 displays a label ID hit by the search (the same as the entered label ID) and a series of label IDs consecutively associated with the label ID as associated label IDs.

Clicking a displayed label ID displays the detailed information associated with those label IDs.

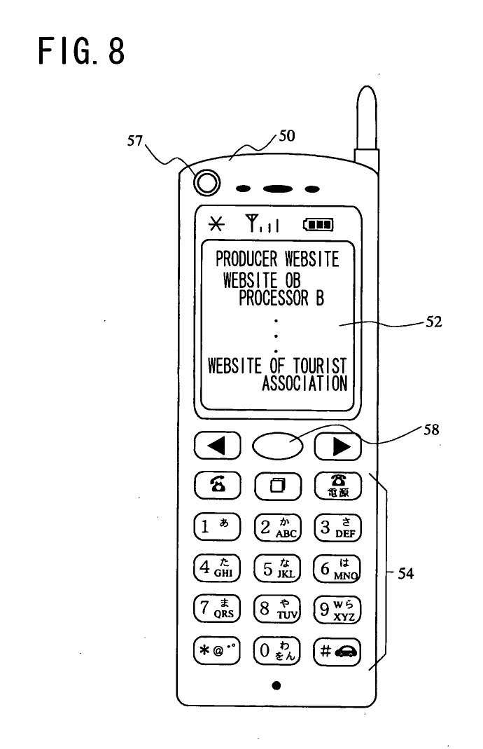

FIG. 7 shows an example of a detailed information screen provided by the search site 13.

The detailed information screen 30 is displayed on the terminal 4 by the consumer selecting the label ID on the search result screen 26.

The label management server 2 obtains detailed information associated with the selected label ID from the label issuing apparatus 5, and the detailed information is used to construct the detailed information screen 30.

The consumer can confirm the detailed information on a purchased product by checking the display contents on the detailed information screen 30.

FIG. 8 is an external view of the portable phone used in this embodiment, which shows how the portable phone is accessing the cell-phone website 14.

The portable phone 50 includes a camera 57, a display unit 52, an operation button 58, and enter buttons 54.

Although not shown, the portable phone 50 incorporates a random access device storing a program or data and including an information processing unit composed of CPU (central processing unit), a ROM (read only memory), a RAM (random access memory), or the like, and for example, an EEPROM (electrically erasable and programmable ROM).

The CPU of the portable phone 50 executes various kinds of information processings in accordance with a program recorded on a ROM or other such storage media.

The RAM provides a working memory used when the CPU extracts the digital watermark from image data of the label or the extracted digital watermark is used to access the cell-phone website 14.

The storage medium stores an auto-access program for causing the CPU to exert a function of extracting the digital watermark through the image processing, a function of obtaining access information from the extracted digital watermark, and a function of automatically accessing a website (in this case, the cell-phone website 14) designated according to the extracted access information, and a browser program for browsing the websites on the Internet 3.

The CUP of the portable phone 50 applies information processing to the information which the consumer enters using the operation button 58 and the enter buttons 54, or information taken by the camera 57, based on a program stored in the storage medium. Then, the CPU enables communications with a server via the Internet 3 or display of the information processing results on the display unit 52.

The camera 57 includes an optical system composed of lenses etc., and a CCD (charge coupled device) for converting a subject's image projected through the optical system into digital data, and the consumer can photograph a label with the camera 57 and convert the data printed on the label into digital data.

The display unit 52 includes a liquid crystal display, for example, and displays information for communications such as a telephone number, and can display various screens sent from the website via the Internet 3 on the browser.

The operation button 58 is used for the consumer to execute various screen operations such as selecting an icon displayed on the display unit 52 and selecting a link, on a screen displayed on the display unit 52.

The enter buttons 54 are used for entering numerals, characters, symbols, etc. to the portable phone 50.

The portable phone 50 has a function of extracting access information to the cell-phone website 14 recorded through the digital watermarking from digital label image data and automatically accessing the cell-phone website 14 using the extracted information.

When the portable phone accesses the cell-phone website 14 using this function, a link selection screen provided by the cell-phone website 14 is displayed as shown in FIG. 8.

The consumer selecting a desired operator on the link selection screen, the access information to the operator website is sent from the label management server 2. Then, the portable phone 50 accesses the selected operator website using the access information.

FIG. 9 shows how the portable phone 50 is accessing the operator website.

In an illustrated example of FIG. 9, a website of “Yamada Farm” which produces a beef product is selected.

This screen contains an item list box 56 that displays various options such as “introduction”, “farm information”, and “local sight spots”, and the consumer can obtain more detailed information about an interesting item by clicking the item.

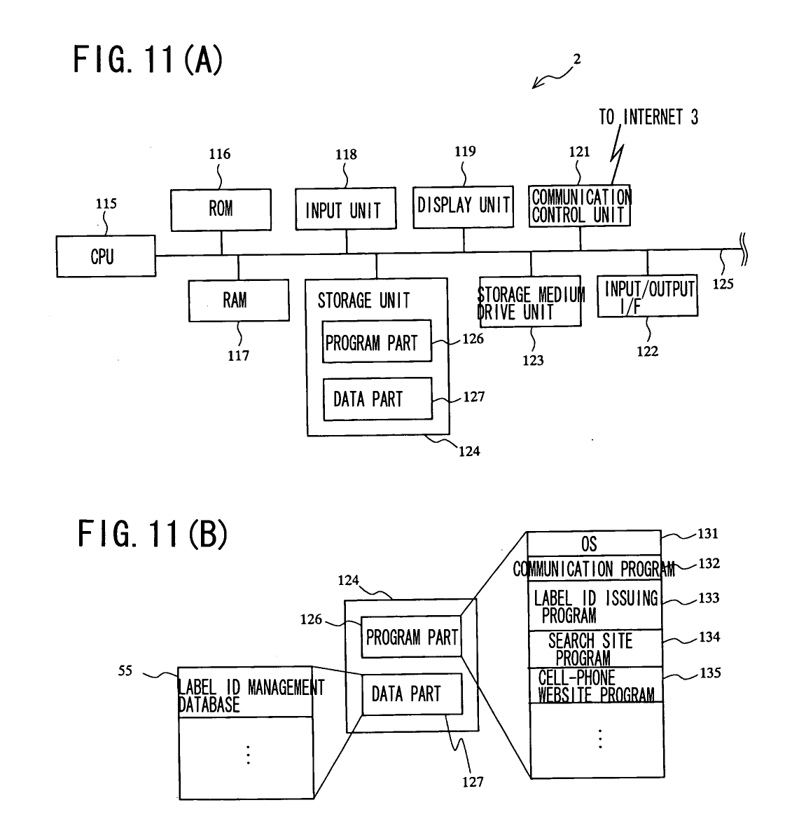

FIG. 10 is a flowchart illustrative of a procedure for accessing the operator website by use of the portable phone.

First, the consumer photographs a label affixed onto a product with the portable phone to thereby obtain label image data (step S5).

Next, the information recorded through the digital watermarking is extracted from the label image data by use of the portable phone, and then it is judged whether or not the extracted information is access information to the website. If the judgement result is positive, the portable phone accesses an address designated by the access information.

In this case, the access information to the cell-phone website 14 is being printed on the label in the digital-watermarked form, so the portable phone serves to extract the access information to the cell-phone website 14 (step S10).

Then, the portable phone accesses the cell-phone website 14 using the extracted access information (step S15).

The portable phone accessing the cell-phone website 14, the label management server 2 transmits link selection screen data to the portable phone (step S20).

The portable phone receives the link selection screen data from the label management server 2, and displays the link selection screen on the display unit 52 (FIG. 8) using the data (step S25).

When the consumer selects a desired operator website using the link selection screen data, the portable phone accesses the operator website using the access information to the operator website (one included in the link selection screen data is used) (step S30) The server 11 running the operator website of the selected operator accepts an access from the portable phone and transmits the screen data of the operator website to the portable phone (step S35).

The portable phone receives the screen data from the server 11 and displays the screen provided by the operator website using the data (step S40).

FIGS. 11A and 11B are block diagrams each showing an example of a hardware configuration of the label management server 2.

The label management server 2 is configured by a CPU 115, a ROM 116, a RAM 117, an input unit 118, a display unit 119, a communication control unit 121, an input/output interface (I/F) 122, a storage medium drive unit 123, and a storage unit 124. The respective functional parts are connected via a bus line 125.

The CPU 115 is a central processing unit for performing various arithmetic processings and information processing, or controlling respective components of the label management server 2 based on a predetermined program.

In this embodiment, for example, the CPU 115 communicates with the label issuing apparatus 5 to exchange the label IDs or transmit the access information to the cell-phone website 14.

The ROM 116 is a read only memory that stores a basic program or data for operating the label management server 2.

The RAM 117 is a random access memory that provides a working area for the CPU 115 to operate.

The input unit 118 is a functional part for inputting information to the label management server 2 and has a keyboard or mouse, for instance.

The keyboard includes character keys for inputting numerals and characters, a numeric keypad, and function keys for designating preset functions, and is used for an administrator to perform maintenance on the label management server 2, for example.

Further, when an organizer of the label management server 2 is requested to add, change, and delete the access information to the search site 13 or cell-phone website 14 by operators in each step, the administrator inputs information by means of the input unit 118, edits the contents posted on the search site 13 or cell-phone website 14, and updates the sites to latest ones.

In this way, the label management server 2 has posting information accepting means for accepting registration of information to be posted on a predetermined website from operators in each step (which is inputted by the operator using the input unit 118, for example), and posting means for posting the accepted posting information on the predetermined website.

The display unit 119 has a display device for displaying text or image information, and is used for the administrator to perform maintenance on the label management server 2, for example.

The display device includes a CRT (cathode-ray tube) display, a liquid crystal display, and a plasma display.

The communication control unit 121 is a functional part for connecting the label management server 2 to the Internet 3. The label management server 2 can communicate with the label issuing apparatuses 5, the terminals 4, the portable phone, or the like, through the communication control unit 121.

The input/output I/F 122 is an interface for extending the function of the label management server 2 by connecting the label management server 2 to an external device. Examples of the connectable external device include a storage device such as a hard disk or semiconductor memory device.

The storage medium drive unit 123 is a functional part for driving a removably inserted storage medium to read and write data.

The random access memory (storage medium) is, for example, a flexible disk, a magneto-optical disk, a semiconductor memory device, a magnetic tape, or a paper tape.

Also, the read only memory (storage medium) is, for example, an optical disk such as a CD-ROM.

The label management server 2 can install a program from the storage medium inserted to the storage medium drive unit 123 and also backup the linkage information 15 between the label IDs or other such important information to the storage medium.

The storage unit 124 is, for example, a random access memory (storage device) with a large capacity, which is configured by a hard disk or the like.

A program part 126 storing programs and a data part 127 storing data are provided in the storage unit 124.

As shown in FIG. 11B, the program part 126 stores various programs, for example, an operating system (OS) 131, a communication program 132, a label ID issuing program 133, a search site program 134, and a cell-phone website program 135, . . . , which can be run by the CPU 115.

The OS 131 is a program for causing the CPU 115 to exert the basic function of operating the label management server 2 such as managing the input/output of files or controlling various functional parts.

The communication program 132 is a program for causing the CPU 115 to exert a function of controlling the communication control unit 121 and enabling communications via the Internet 3.

The label ID issuing program 133 is a program for causing the label issuing apparatus 5 to issue a label, which functions to receive a label ID from the label issuing apparatus 5, and issue and transmit a label ID in association with the received label ID to the label issuing apparatus 5.

The search site program 134 is a program for running the search site 13.

The CUP 115 executes the search site program 134 to accept an inquiry about a label ID or detailed information from the terminal 4 via the Internet 3, and besides exerts, when receiving a request to search for detailed information, a function of retrieving the corresponding detailed information from the label issuing apparatus 5 and providing the information.

The cell-phone website program 135 is a program for running the cell-phone website 14.

Further, the data part 127 includes the label ID management database 55.

The hardware configuration of the label management server 2 has been described so far, but the hardware configurations of the label issuing apparatus 5 and the label management server 2 are basically the same.

For the label issuing apparatus 5, a print unit for printing a label is added to the configuration of FIGS. 11A and 11B, and a label ID sent from the label management server 2 or a digital watermark is printed on a print medium (label).

The print unit includes various types of printing apparatuses such as a laser printer, an inkjet printer, and a direct thermal printer.

A printer for special printing may be used as the printing apparatus, which hardly allows any counterfeit. A printer for printing holograph on the label is given as an example thereof.

According to the above-mentioned embodiment of the present invention, the following beneficial effects can be attained. (1) Even if a label surface does not have enough printing space, the operator can immediately print any information which he/she wishes to provide to a consumer or the like, through the digital watermarking.

The consumer can access an operator website containing information provided by the operator using the digital watermark to thereby browse desired information.

Consequently, the information can be provided in real time independently of a label's indication area. (2) When the portable phone automatically accessible to the designated website using the access information printed through the digital watermarking and read from a taken image is used, the consumer can automatically access the operator website only by photographing a label with the portable phone. (3) It is possible to offer options about which information is printed on a label as visible information and which information is provided in the form of invisible information. (4) The label provided to a consumer is a print, but the information can be provided without limiting its form to the print by accessing a predetermined website using the access information printed on a label. (5) As regards the normal printing, it is difficult to add any other information after printing, and the information is not changed nor provided in real time. In contrast, when the access information to the website is printed, the latest information can be provided to the consumer.

Thus, the technique of the above embodiment may be applied to a label affixed to a food product to provide product (fresh food) information or provide promotion information in the retail industry. Alternatively, the technique of the above embodiment may be applied to a label affixed to pharmaceuticals to immediately provide specific information about health and medical information.

Note that in this embodiment, information on the operator posted on the search site 13 or the cell-phone website 14 is set as the access information. However, this is cited as an example. Instead, various types of data provided by the operator (text data, image data, audio data, etc.) can be placed on the website.

Further, the information to be placed on the cell-phone website 14 is not limited to information on operators but information on another person may be placed.

In this case, an operator of the label management server 2 can obtain an advantage by collecting insertion fees for information from the person.

Besides, in this embodiment, a label made up of a print medium is used as the recording medium, and the printing apparatus for printing the visible information and invisible information on the label surface is used as the recording means. However, this does not intend to limit the recording medium and the recording means to the label and the printing apparatus, respectively.

For example, an IC tag may be used as the recording medium, and a reader/writer for reading/writing information with respect to an IC tag can be used as well, as the recording means.

In this case, it is possible that the access information stored in the IC tag is read with a portable phone compatible to the IC tag to automatically access the cell-phone website 14.

Further, a magnetic stripe or other such magnetic recording media can be used as a recording medium.

In addition, in this embodiment, the access information is printed on the label in the final step, but may be printed with the label issuing apparatus 5 set for any intermediate step. In this case, an operator involved in a step next to the above step may access a predetermined website using the access information.

Further, in this embodiment, the label management server 2 manages both the issuance of a label ID and the access to the cell-phone website 14, but those operations maybe assigned to different servers. In this case, the servers constitute the product history management apparatus in combination.

What is claimed is:

1. A product history management apparatus used for a product history management system for managing a product history by attaching a recording medium having recorded identification information to products provided in steps from raw material production to final product production, comprising:
identification information receiving means for receiving identification information recorded on the recording medium attached in a previous step from an identification information issuing apparatus;
identification information transmitting means for transmitting newly issued identification information to the identification information issuing apparatus;
identification information storage means for storing the received identification information and the transmitted identification information in association with each other; and
access information transmitting means for transmitting access information to a predetermined site to be recorded together with the transmitted identification information, to the identification information issuing apparatus.

2. A product history management apparatus according to claim 1, further comprising:
posting information accepting means for accepting registration of posting information to be posted on the predetermined website from operators in each of the steps; and
posting means for posting the accepted posting information on the predetermined website.

3. A product history management apparatus according to claim 2, wherein the posting information comprises access information to a website designated by the operator.

4. An identification information issuing apparatus used for a product history management system for managing a product history by attaching a recording medium having recorded identification information to products provided in steps from raw material production to final product production, comprising:
identification information transmitting means for transmitting identification information recorded on the recording medium attached in a step previous to a step where the identification information issuing apparatus is set, to a product history management apparatus;
identification information receiving means for receiving identification information issued with respect to the transmitted identification information from the product history management apparatus; and
recording means for obtaining access information to a predetermined website and recording the received identification information and the access information on the recording medium.

5. An identification information issuing apparatus according to claim 4, wherein:
the recording medium comprises a print medium; and
the recording means prints and superimposes the access information on visible information in a form of a digital watermark readable with a terminal device having a digital-watermark-reading function.

6. A product history management system for managing a product history by attaching a recording medium having recorded identification information to products provided in steps from raw material production to final product production, comprising:
a plurality of identification information issuing apparatuses set for each of the steps; and
a product history management apparatus connected with the identification information issuing apparatuses via a network,
the identification information issuing apparatuses transmitting identification information recorded on the recording medium attached in a previous step to the product history management apparatus,
the product history management apparatus receiving the transmitted identification information, newly issuing identification information, storing the issued identification information and the received identification information in association with each other, and transmitting the issued identification information and access information to a predetermined website to the identification information issuing apparatus set for the step,
the identification information issuing apparatus, which has transmitted the identification information, receiving the transmitted identification information and access information to the predetermined website, and storing the received information on the recording medium.
